(19) United States
(12) Patent Application Publication
(10) Pub. No.: US 2013/0241905 A1
(43) Pub. Date: Sep. 19, 2013

(54) STEREOSCOPIC DISPLAY DEVICE

(71) Applicant: SAMSUNG DISPLAY CO., LTD., Yongin-si (KR)

(72) Inventors: Duk-Sung KIM, Asan-si (KR); Young-Jae TAK, Yongin-si (KR)

(73) Assignee: Samsung Display Co., Ltd., Yongin-si (KR)

(21) Appl. No.: 13/836,997

(22) Filed: Mar. 15, 2013

(30) Foreign Application Priority Data
Mar. 16, 2012 (KR) 10-2012-0027403

(51) Int. Cl. G09G 3/36

(52) U.S. Cl. CPC G09G 3/3611
USPC 345/204; 345/55

(57) ABSTRACT

A stereoscopic display device is disclosed. The stereoscopy display device includes pixels arranged in rows and columns. The pixels are divided into pixel groups, each including a plurality of adjacent rows. Interference prevention patterns may be located between the pixel groups. Phase delay layers are disposed on the interference prevention patterns and have different phases. At least one storage electrode line may extend between the pixels in a direction of the rows. The stereoscopic display device prevents interference between left and right-eye images and has high luminance.

### CROSS REFERENCE TO RELATED APPLICATION

This application claims priority from and the benefit of a Korean Patent Application No. 10-2012-0027403, filed on Mar. 16, 2012, which is hereby incorporated by reference for all purposes as if fully set forth herein.

### BACKGROUND OF THE INVENTION

1. Field of the Invention

Exemplary embodiments of the present invention relate to a stereoscopic display device capable of preventing interference and improving luminance.

2. Discussion of the Background

A stereoscopic display device (or stereoscopic image display device) is a display device that allows a viewer watching the display device to recognize different images with both eyes so that the viewer may feel a stereoscopic effect similar to what he or she may observe in a life (e.g., non-display) environment.

The stereoscopic display device may provide a different viewing experience from a viewing experience of a viewer watching the same image displayed on a conventional flat display device.

Recently, a variety of methods for implementing a stereoscopic display device have been developed and used. These methods may be classified into a stereoscopic scheme for allowing different images to be incident on two of the viewer's eyes with the use of glasses, and an auto-stereoscopic scheme for allowing different images to be incident on two of the viewer's eyes by adjusting directions of images coming from the display device.

Implementations of a stereoscopic scheme-based stereoscopic display device may be classified into a shutter glass scheme and a non-shutter glass scheme. According to the shutter glass scheme, an image may be sent to the right eye and a subsequent image may be sent to the left eye over time in an iterative manner by time-dividing the image sent to the right eye and the image sent to the left eye in the display device. Each of the left/right eyeglasses passes its associated eye's image signal and shuts (or blocks) the opposite eye's image signal. According to the non-shutter glass scheme, pixels may be designated to implement an image signal sent to the right eye and an image signal sent to the left eye. The image signals may be implemented independently by space-dividing the stereoscopic display device. Each of the left/right eyeglasses passes an image signal from its associated pixels and blocks an image signal implemented by the other pixels.

The non-shutter glass scheme may also be referred to as a Film Patterned Retarder (FPR) scheme, in which a phase retarder (or phase delay layer) may overlap pixels of the display device. The phase retarder is formed such that a phase retarder overlapping the left-eye pixels is different in characteristics from a phase retarder overlapping the right-eye pixels, so the left/right eyeglasses may select and pass left/right-eye pixel signals, respectively.

In the FPR scheme, when the display device is viewed in a tilted direction, at the boundary between the left and right pixels, light from right-eye pixels may pass through the left-eye retarder and light from left-eye pixels may pass through the right-eye retarder. This is called interference (or crosstalk). This is one of the shortcomings of the FPR scheme that occur because the layer where the retarders are formed is different from the layer where the pixels are formed.

Therefore, an opaque pattern for interference prevention is formed at the boundary between the left and right pixels, or at the boundary between the left and right retarders. An interference angle is determined depending on the width of the interference prevention pattern. To secure the sufficient angle at which no interference may occur, the opaque pattern for interference prevention can be implemented to have a predetermined width.

However, because the interference prevention pattern is formed of an opaque film having a relatively wide width, a light transmission area of the display device is narrow, causing a decrease in brightness of the display device. In addition, even though the pixels are reduced in size due to an increase in resolution of the display device, the interference prevention pattern should have the same width in order to secure an interference prevention angle. As a result, as a resolution of the display device increases, the interference prevention pattern may further reduce the brightness of the display device undesirably.

### SUMMARY OF THE INVENTION

Exemplary embodiments of the present invention provide a stereoscopic display device having an interference prevention pattern favorable to the improvement of luminance.

Additional features of the invention will be set forth in the description which follows, and in part will be apparent from the description, or may be learned by practice of the invention.

Exemplary embodiments of the present invention disclose a display device. The display device includes pixels, interference prevention patterns, phase delay layers, and at least one storage electrode line. The pixels are arranged in rows and columns, and are divided into pixel groups. The interference prevention patterns are disposed between the pixel groups. The phase delay layers are disposed on the interference prevention patterns and have different phases. The at least one storage electrode line is disposed between adjacent pixel groups and extends in a direction parallel to a direction the rows are extending in.

Exemplary embodiments of the present invention disclose a display device. The display device includes pixels, interference prevention patterns, phase delay layers, and at least one storage electrode line. The pixels are arranged in a plurality of rows and a plurality of columns. The plurality of rows includes groups of adjacent rows. The interference prevention patterns are disposed between adjacent groups of the groups of adjacent rows. The phase delay layers are disposed on the interference prevention patterns and have different phase delay features. The at least one storage electrode line is disposed between the adjacent groups of adjacent rows and extends in a direction parallel to a direction the plurality of rows is extending in.

Exemplary embodiments of the present invention disclose a display device. The display device includes pixels, a first pixel group, a second pixel group, an interference prevention pattern, a first phase delay layer, a second phase delay layer, a first storage electrode line, and a second storage electrode line. The pixels are arranged in rows and columns. The pixels include first pixels arranged in a first direction, second pixels arranged adjacent to the first pixels in the first direction, third pixels arranged in the first direction to be spaced apart from the first pixels, and fourth pixels arranged adjacent to the third pixels in the first direction. The first pixel group includes the first pixels and the second pixels. The second pixel group includes the third pixels and the fourth pixels and is adjacent to the first pixel group. The interference prevention pattern is disposed between the first pixel group and the second pixel group. The first phase delay layer overlaps the first pixel group and extends in the first direction. The second phase delay layer overlaps the second pixel group, extends in the first direction, and has different phase delay features compared to the phase delay features of the first phase delay layer. The first storage electrode line extends between the first pixels and the second pixels in the first direction. The second storage electrode line extends between the third pixels and the fourth pixels in the first direction.

Exemplary embodiments of the invention also disclose a display device including a plurality of pixel rows, an opaque layer, at least one signal line, and at least one storage electrode line. The plurality of pixel rows includes at least a first group of pixel rows and a second group of pixel rows. The first group of pixel rows includes at least a first pixel row and a second pixel row. The second group of pixel rows includes at least a third pixel row and a fourth pixel row. The opaque layer separates the first group of pixel rows from the second group of pixel rows. The at least one signal line overlaps the opaque layer and is connected to pixels in the second pixel row and pixels in the third pixel row. The at least one storage electrode line overlaps a gap between the first pixel row and the second pixel row.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a partial cross-sectional view of a stereoscopic image display device according to exemplary embodiments of the present invention.

FIG. 2 is a plane view of a stereoscopic image display device according to exemplary embodiments of the present invention.

FIG. 3 is a plane view of a stereoscopic image display device according to exemplary embodiments of the present invention.

FIG. 4 is a plane view of a stereoscopic image display device according to exemplary embodiments of the present invention.

FIG. 5 is a plane view of a stereoscopic image display device according to exemplary embodiments of the present invention.

FIG. 6 is a plane view of a stereoscopic image display device according to exemplary embodiments of the present invention.

FIG. 7A is a plane view of a TFT substrate of a stereoscopic image display device according to exemplary embodiments of the present invention.

FIG. 7B is a cross-sectional view taken along a line V-V′ of FIG. 7A.

FIG. 8 is a plane view of a TFT substrate of a stereoscopic image display device according to exemplary embodiments of the present invention.

FIGS. 9, 10, 11, 12, and 13 are plane views showing a process of manufacturing a TFT substrate of a stereoscopic image display device according to exemplary embodiments of the present invention.

FIGS. 14, 15, 16, 17, and 18 are plane views showing a process of manufacturing a TFT substrate of a stereoscopic image display device according to exemplary embodiments of the present invention.

### DETAILED DESCRIPTION OF ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It may also be understood that for the purposes of this disclosure, “at least one of X, Y, and Z” can be construed as X only, Y only, Z only, or any combination of two or more items X, Y, and Z (e.g., XYZ, XYY, YZ, ZZ).

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing exemplary embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Hereinafter, exemplary embodiments of the present invention will be described in detail with reference to the accompanying drawings.

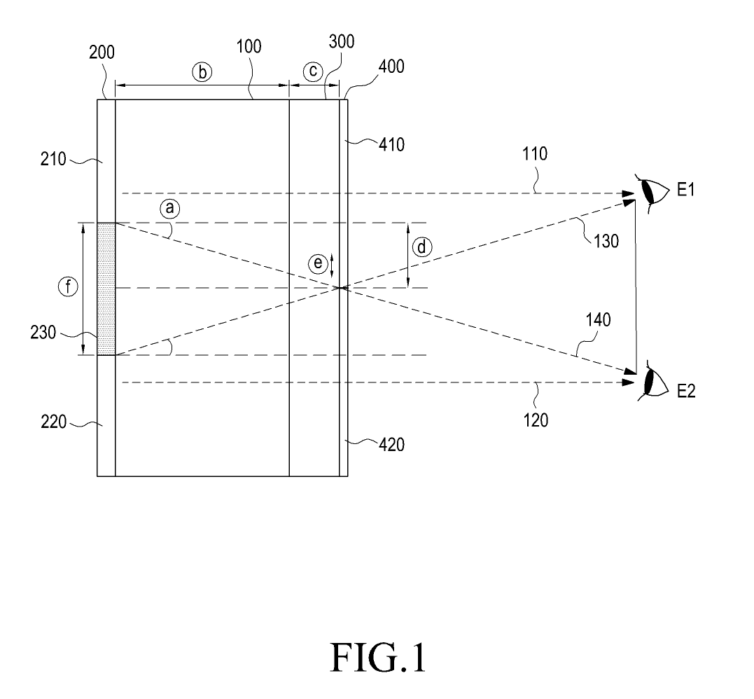

FIG. 1 is a partial cross-sectional view of a stereoscopic image display device according to exemplary embodiments of the present invention.

Referring to FIG. 1, a substrate 100 may be a glass or transparent plastic substrate. The substrate 100 may be an upper-plate glass or an upper-plate plastic in a Liquid Crystal Display (LCD) panel, and may be a capping glass or a capping plastic in an Organic Light-Emitting Diode (OLED) display. Pixels 210 and 220 in the LCD panel may include color filters and upper-plate electrodes, and a liquid crystal layer and a lower-plate pixel area (not shown). Pixels 210 and 220 in the OLED may include a lower-plate pixel area (not shown), although only an upper-plate pixel area is shown. Pixels 210 and 220 implementing pixel signals may be formed on the left side of the substrate 100, while a polarizer 300 and retarders 400 are attached to the right side of the substrate 100. The retarders 400 may include a left-eye retarder 410 and a right-eye retarder 420, which may have materials having different phases, respectively. The retarders 400 may be disposed above an opaque pattern 230. Pixel 210 may correspond to a left-eye pixel, and pixel 220 may correspond to a right-eye pixel. As shown by a first path 110, light coming out from the left-eye pixel 210 and passing through the left-eye retarder 410 may be recognized by the user's left eye E1. As shown by a second path 120, light coming out from the right-eye pixel 220 and passing through the right-eye retarder 420 may be recognized by the user's right eye E2. When the display device is viewed at a tilted angle, light coming out from the right-eye pixel 220 and passing through the left-eye retarder 410, as shown by a third path 130, may be viewed by the left eye E1. As shown by a fourth path 140, light coming out from the left-eye pixel 210 and passing through the right-eye retarder 420 may be viewed by the right eye E2. If part of a light signal from the left-eye pixel 210 passes through the right-eye retarder 420, the user may view part of the left-eye image with the right eye, and if part of the right-eye image passes through the left-eye retarder 410, the user may view part of the right-eye image with the left eye. In these cases, the left-eye image and part of the right-eye image may be recognized simultaneously by the left eye, and the right-eye image and part of the left-eye image may be recognized simultaneously by the right eye. Such a visual experience is called an interference of images. When image interference occurs, the quality of stereoscopic images may be significantly degraded. To solve this problem, the opaque pattern 230 may be formed between the left-eye pixel 210 and the right-eye pixe1220 to expand the area where no image interference occurs. The opaque pattern 230 will be referred as an interference prevention pattern.

An angle at which image interference may occur is determined by a ratio of a width ‘f’ of the interference prevention pattern 230 to a distance ‘b+c’ from the pixels 210 and 220 to the retarders 410 and 420. Therefore, an angle ‘a’, at which image interference may occur, may be adjusted based on the thickness ‘b’ of the substrate 100, the thickness ‘c’ of the polarizer 300, and the width ‘f’ of the interference prevention pattern 230. An increase in the width ‘f’ of the interference prevention pattern 230 may result in disadvantages, because as the width ‘f’ of the interference prevention pattern 230 increases, the light transmission area of the display device decreases. If the thicknesses ‘b’ and ‘c’ of the substrate 100 and the polarizer 300, respectively, are relatively small, the area where no image interference occurs may be advantageously large. However relatively small thicknesses ‘b’ and ‘c’ of the substrate 100 and the polarizer 300 may cause a decrease in product reliability, so there is a limitation in reducing the thicknesses of the substrate 100 and the polarizer 300. According to exemplary embodiments of the invention, in some cases, the thickness ‘b’ of the substrate 100 may be about 700 μm and the thickness ‘c’ of the polarizer 300 may be about 194 μm. Therefore, when the thicknesses ‘b’ and ‘c’ of the substrate 100 and the polarizer 300 are larger than 700 μm and 194 μm, respectively, an interference prevention angle may be adjusted based on the width ‘f’ of the interference prevention pattern 230. The interference prevention angle may be greater than or equal to a predetermined angle depending on the interference prevention angle desired by the market. Because the angle presently desired by the market is about 7° both upward and downward, specifications of the currently used parts may, in some cases, be shown as follows, with reference to FIG. 1.

a: viewing angle=7°

b: thickness of substrate 100=700 μm

c: thickness of polarizer 300=194 μm

d: f/2

e: attachment tolerance=10 μm

f: width of interference prevention pattern=2d=2 ((b+c) tan a)≈220 μm.

Because an attachment/arrangement tolerance ‘e’ of the substrate 100 and the polarizer 300 may be about 5 μm both upward and downward, to secure the interference prevention angle, the interference prevention pattern 230 may be formed wider upward and downward by 5 μm taking into account the allowable arrangement tolerance ‘e’. Therefore, a sum of the width of the interference prevention pattern 230, calculated on the basis of the exact arrangement, and a sum (=10 μm) of the up and down margins is about 230 μm. To make a stereoscopic display device where no interference occurs at up to 7° upward and downward, the width ‘f’ of the interference prevention pattern 230 can be 230 μm or more on the basis of the specifications of the substrate 100 and the polarizer 300. The width ‘f’ of the interference prevention pattern 230 may not change despite the changes in resolution and size of the flat display device because the width ‘f’ may be set based on the thickness ‘b’ of the substrate 100, the thickness ‘c’ of the polarizer 300, and the viewing angle ‘a’. As the size of the pixels 210 and 220 decreases, the pixel's aperture may also significantly decrease. Table 1 shows a ratio of an interference prevention pattern with respect to the size and resolution of a display device.

TABLE 1

| | | Ratio of interference prevention |
|---|---|---|
| Size (diagonal) | Resolution | pattern's width to pixel length |
| 41″ | 1920*1080 | 50% |
| 45″ | 1920*1080 | 44% |
| 55″ | 1920*1080 | 40% |

Even though products with a higher resolution may improve the image quality, the width ‘f’ of the interference prevention pattern may not be reduced to improve the viewing angle. When a display device with a resolution of 3840*2160 is made, the display device's unit pixel length may be half the pixel length of display devices having a resolution shown in Table 1. With respect to the display devices exemplified in Table 1, 80% or more of the pixels may be covered by the interference prevention pattern 230. For a display device of the size of 55″, about 80% of the pixels may be covered by the interference prevention pattern 230. An increase in the number of pixels covered by the interference prevention pattern 230 may be fatal to the image quality due to a decrease in luminosity.

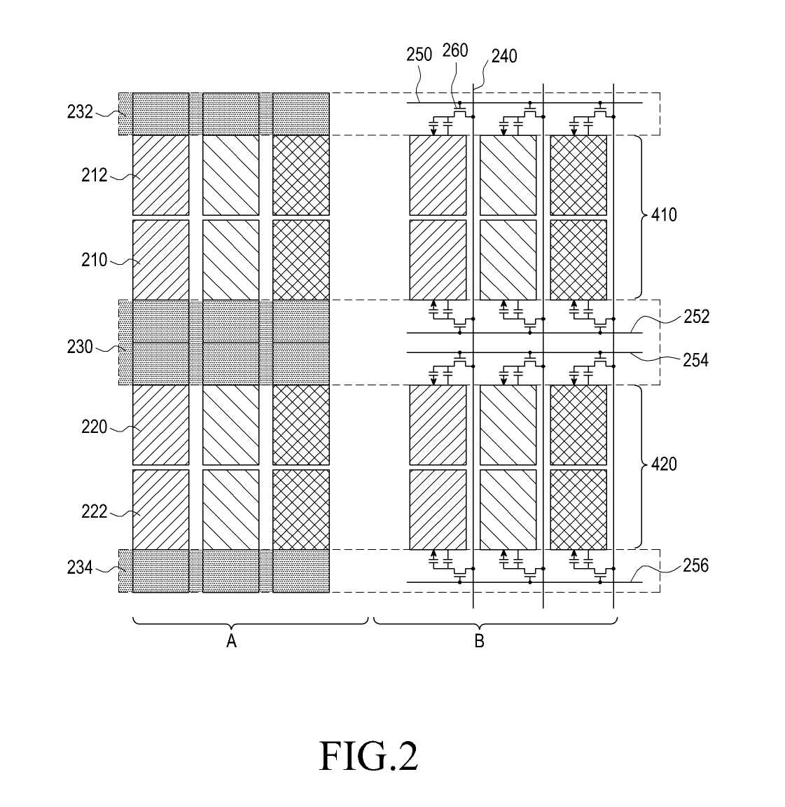

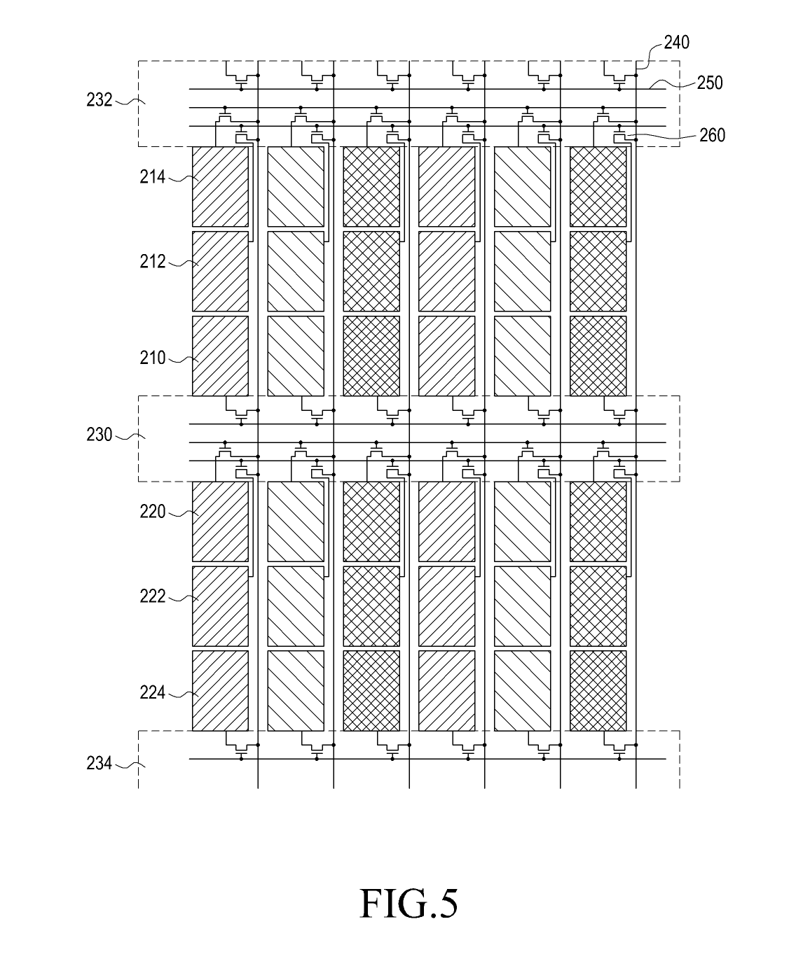

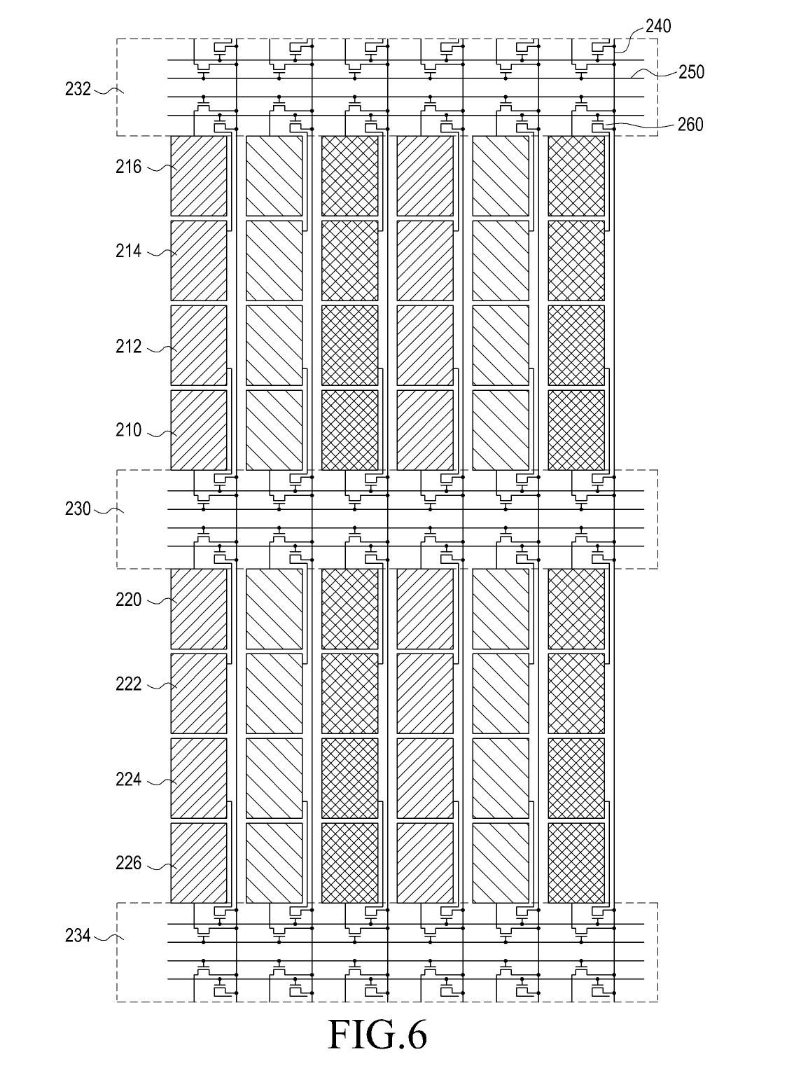

FIG. 2 is a plane view of a stereoscopic image display device according to exemplary embodiments of the present invention. Referring to FIG. 2, pixels may be arranged in rows and columns. The rows may be arranged in pairs of two adjacent rows, and pixels may be arranged adjacent to each other in the pairs of rows. Interference prevention patterns 230, 232, and 234 may be disposed between the pixels in the pairs of rows. Pixel pairs existing in the pairs of adjacent rows may be arranged between the interference prevention patterns 230, 232, and 234 extending in the row direction. Pixel rows 210 and 212 may be formed between interference prevention patterns 230 and 232, and pixel rows 220 and 222 may be formed between interference prevention patterns 230 and 234. The interference prevention pattern 230 is needed between a left-eye retarder 410 and a right-eye retarder 420 to prevent mixing of a left-eye image and a right-eye image. The left-eye retarder 410 may overlap the pixel rows 210 and 212, and the right-eye retarder 420 may overlap the pixel rows 220 and 222. Accordingly, even though one interference prevention pattern may be formed per two pixel rows as shown in FIG. 2, no right-eye image may reach the left eye and no left-eye image may reach the right eye. A width ‘f’ of the interference prevention patterns 230, 232, and 234 may be determined based on a substrate's thickness ‘b’, a polarizer's thickness ‘c’, and an interference viewing angle ‘a’. Accordingly, an area of the pixels covered by the interference prevention patterns may be reduced by half, compared to a display device in which an interference prevention pattern is implemented between every pixel row. For example, if the display device has a size of 55″, the area of the pixels covered by the interference prevention patterns may be reduced to about 40% of the pixels while the resolution of 3840*2160 is implemented. Compared to the above example where 80% of the pixels are covered, when 40% of the pixel area is covered by the interference prevention patterns, 60% of the pixel area is uncovered. When 80% of the pixel area is covered, the uncovered pixel area is 20%. Therefore, when the pixel's apertures are compared relatively, the pixel aperture of a display device according to exemplary embodiments of the invention may be three times the pixel aperture of a conventional display device. Accordingly, the luminance of a display device may be improved 3 times. Though the aperture improvement ratio may vary depending on the size and resolution of the display devices, exemplary embodiments of the invention may provide several advantages such as the improvement of luminance and reduction in power consumption of the stereoscopic display device by improving the aperture ratio of the stereoscopic display device. Although FIG. 2 shows an example of implementing one interference prevention pattern per two pixel rows, it will be understood by those of ordinary skill in the art that one interference prevention pattern may be implemented per three or four or more pixel rows in the same way as shown in FIGS. 5 and 6.

As shown in FIG. 2, wirings 240 and 250 and an electrical element 260 for applying an electrical signal to each pixel may be formed between pixels. If the wirings 240 and 250 and the electrical element 260 are exposed, the exposed wirings may deteriorate the image quality. Therefore, an opaque film may be formed to overlap the portion where the wirings 240 and 250 and the electrical element 260 are located, preventing the wirings 240 and 250 and the electrical element 260 from being exposed to the viewers. In some cases, the wirings 240 and 250 and the electrical element 260 may be formed at a position overlapping the interference prevention pattern 230 to prevent the exposure of the wirings 240 and 250 and the electrical element 260, making it possible to omit the process of forming a separate opaque pattern for preventing their exposure. The wirings 240 and 250 and the electrical element 260 may be formed in various different ways depending on the types of the display devices, and the structure shown in FIG. 2 is an example of a structure of an LCD device. Wirings of the LCD device may include a gate line 250 and a data line 240, and the electrical element 260 may include a Thin Film Transistor (TFT). Even in the LCD device, an opaque film may be formed to overlap a portion where the wirings 240 and 250 and the electrical element 260 are located, so that the wirings 240 and 250 and the electrical element 260 may not be visible to the viewer. In some cases, the wirings 240 and 250 and the electrical element 260 may be formed at a position overlapping the interference prevention pattern 230, making it possible to prevent a waste of space and materials, which may occur when an opaque material is formed in a separate position. In a section A (or left area) of FIG. 2, the opaque interference prevention patterns 230, 232, and 234 are represented opaquely, but in a section B (or right area), they are drawn in the form of perspective drawing to show the structure of the wirings 240 and 250 and the electrical element 260 formed under the opaque interference prevention patterns 230, 232, and 234. Since the interference prevention patterns 230, 232 and 234 (or opaque film) may be formed in both sections A and B in display devices, the wirings 240 and 250 and the electrical element 260 formed under the interference prevention patterns 230, 232, and 234 may not be seen by the viewer.

In FIG. 2, the gate line (or gate signal line) 250 may extend in the direction in which the interference prevention patterns 230, 232, and 234 extend. Because the width of the interference prevention patterns 230, 232, and 234 is sufficiently wide, forming the gate line 250 (or electrical signal line) extending in the direction in which the interference prevention patterns 230, 232, and 234 extend to overlap the interference prevention patterns 230, 232, and 234 may be advantageous in expanding the aperture area of the pixel area. If an electrical signal line extending in the direction in which the interference prevention patterns 230, 232, and 234 extend is formed in the portion where there is no interference prevention pattern, a space for forming the electrical signal line may be provided separately resulting in a corresponding reduction in the aperture area of the pixels. In addition, disadvantageously, opaque patterns with a wider width may need to be formed to cover the electrical signal line.

FIG. 2 illustrates a display device with 2 pixel rows arranged between two interference prevention patterns. Gate lines 252 and 254 overlapping interference prevention pattern 230 may supply a gate signal to the pixels in two rows (e.g., rows 210 and 220). A number of wirings overlapping one of the interference prevention patterns 230, 232, and 234 may be determined depending on the number of pixel rows to which one of the wirings overlapping the interference prevention patterns 230, 232, and 234 supplies a gate signal, and the number of pixel rows disposed between two adjacent interference prevention patterns. In particular, the number of gate lines overlapping one interference prevention pattern may be determined by: 1) multiplying the number of pixel rows overlapping a phase delay pattern by the number of pixels to which a gate signal line extending in the same direction as the interference prevention pattern supplies a gate signal; and 2) dividing the multiplication result by the number of pixels formed in one pixel row. This may be expressed as follows:

N=R*n/p (1)

where N represents the number of gate lines overlapping one interference prevention pattern, R represents the number of pixel rows overlapping a phase delay pattern, n represents the number of pixels to which one gate line supplies a gate signal, and p represents the number of pixels arranged in one pixel row.

Although Equation (1) above may vary at the boundary or some portions of the display device, it may fall within the scope of exemplary embodiments of the invention even though it is applied to most or some of the pixel area.

In FIG. 2, the gate line 250 may extend in a horizontal direction, and the data line 240 may extend in the vertical direction. The TFT 260 may be electrically connected to the gate line 250 and the data line 240. Generally, the higher the resolution a display device has, the lower the display device's aperture ratio becomes. If the resolution is high, the number of pixels of the display device generally increases, resulting in an increase in the number of wirings and switching elements for applying electrical signals to the pixels. Because the reason for increasing the resolution is to improve image quality of the display device, even at the high resolution, the number of frames (or the number of unit images) of the display device should be maintained or increased. If the number of pixels increases, the time a signal takes to be applied to each pixel is reduced. When a unit image frame time is determined or fixed, the time taken for a signal to be applied to a unit pixel may vary depending on the number of scanning signal lines applying a scanning signal to the gate line. If the number of scanning signal lines decreases, the time taken for a signal to be applied to one scanning signal line may increase. To increase the accuracy of a signal applied to a unit pixel, sufficient time must be allocated to apply a signal to a unit pixel. Therefore, if the number of scanning wirings is halved in a high-resolution display device, signals may be applied to the pixels more accurately. Such display device architecture and technology is also referred to as Half Gate Double Data (HG2D) technology, in which the number of scanning wirings is reduced by a half and the number of data lines is doubled.

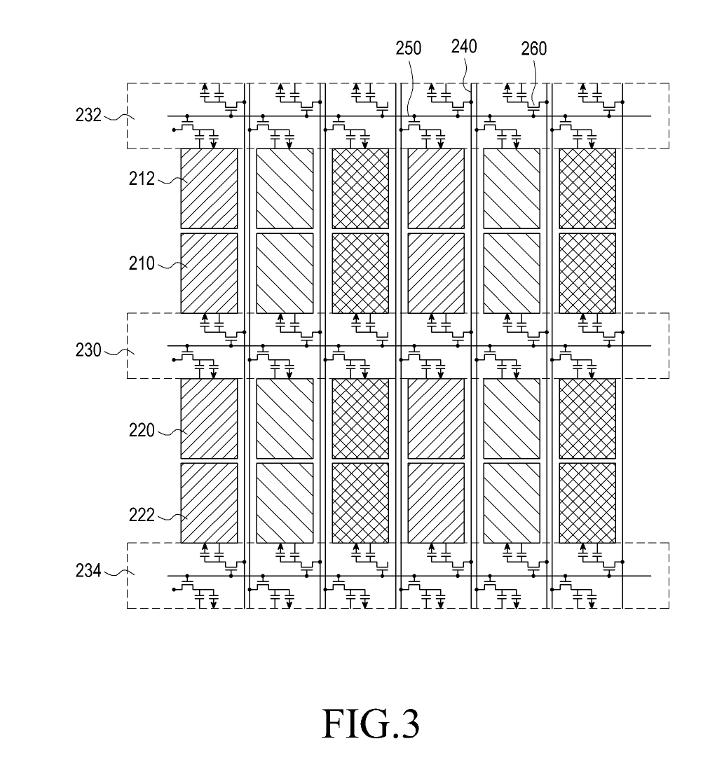

FIG. 3 shows a display device structure having HG2D technology according to exemplary embodiments of the present invention. Referring to FIG. 3, one gate line (e.g., gate line 250) may be formed for every two pixel rows (e.g., pixels 210 and 212 and pixels 220 and 222), and two data lines 240 may be formed for each pixel column. The gate line 250 may provide a scanning signal to adjacent upper and lower pixels, and the data line 240 may provide a signal to a pixel corresponding to half of one column of adjacent pixels. When a display device is manufactured in this way, the number of gate lines 250 may be halved compared to the number of the pixel rows 210, 212, 220, and 222, and the time a signal is applied to each scanning signal line 250 may be doubled, compared to the conventional method in which the number of scanning signal lines is equal to the number of pixel rows. The method of implementing the proposed interference prevention patterns shows excellent effects for the high resolution, and HG2D technology is also needed for the high resolution. Thus, combining the two different schemes in a high-resolution display device as shown in FIG. 3 may advantageously provide a synergistic effect.

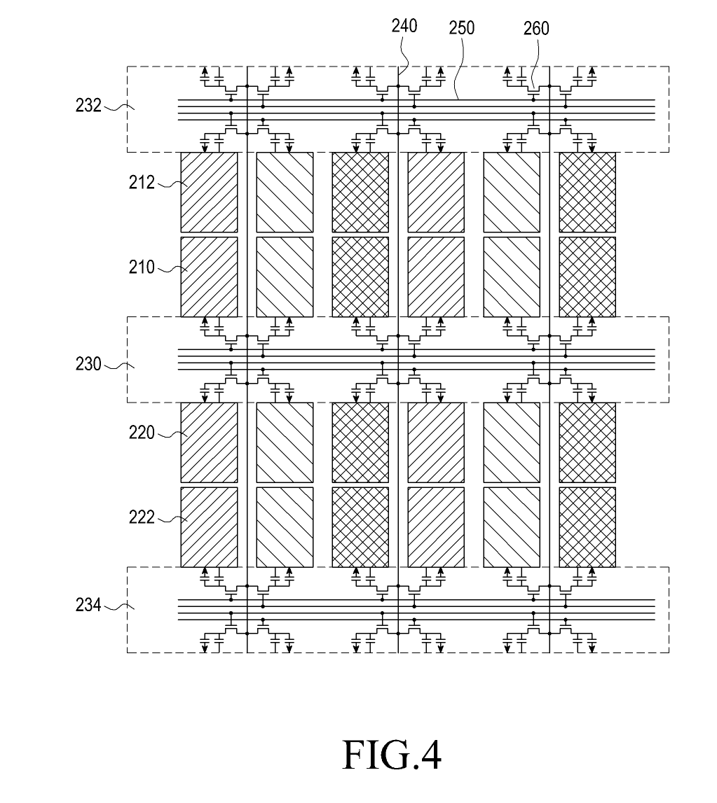

FIG. 4 shows a display device structure having a Double Gate Half Data (2GHD) structure according to exemplary embodiments of the present invention. In FIG. 4, the four gate lines 250 may be formed to overlap one interference prevention pattern 230, 232, or 234. Therefore, even though the 2GHD structure is applied, the reduction in the aperture ratio may not be affected. Instead, due to the reduction in the number of data lines 240, one data line 240 may be formed per two pixel columns, reducing the area where the data lines 240 are formed. Due to the reduction in the area where the data lines 240 are formed, the reduced area may be used as a pixel area, resulting in an improvement of the aperture ratio.

While two or more pixel rows may be adjacent to one another in some portions of the display device, an interference prevention pattern may be formed between the adjacent pixel rows in other portions of the display device. For example, in the case of an LCD device, during its operation, a voltage signal applied to pixels may be inversed on a frame-by-frame basis to prevent afterimages. The voltage inversion involves changing the direction (or polarity) of electrical signals applied to both ends of a liquid crystal layer. In addition, to reduce flickering defects, the polarity of the electrical signals may be changed depending on the location of the pixels. Therefore, voltage inversion may be appropriately adjusted depending on the arrangement of the pixels. In the exemplary embodiment shown in FIG. 2, two pixel rows 210 and 212 (and 220 and 222) are adjacent to each other, and a 2-dot inversion operation (or driving) may be applied. The 2-dot inversion operation may inverse the voltage applied to the data signal line in units of two pixels. If signals with different polarities are applied to pixels with short distances between the pixels, the signal difference may be large, causing a significant distortion of the signals. Therefore, the 2-dot inversion may be applied to reduce the signal distortion.

In some cases, as shown in FIG. 5, pixel rows 210, 212, 214, 220, 222, and 224 may be divided into left-eye pixel rows 210, 212, and 214 and right-eye pixel rows 220, 222, and 224 in units of three pixel rows. In some cases, as shown in FIG. 6, pixel rows 210, 212, 214, 216, 220, 222, 224, and 226 may be divided into left-eye pixel rows 210, 212, 214, and 216 and right-eye pixel rows 220, 222, 224, and 226 in units of four pixel rows. Due to the sufficiently wide width of the interference prevention patterns 230, 232, and 234, three or four or more gate lines 250 may be accommodated in each interference prevention pattern 230, 232, or 234 in an overlapping manner, making it possible to secure a high aperture ratio. When pixel rows are divided into left-eye pixel rows 210, 212, and 214 and right-eye pixel rows 220, 222, and 224 in units of three pixel rows as shown in FIG. 5, the three left-eye pixel rows 210, 212, and 214 are arranged on one side of the interference prevention pattern 230, and the three right-eye pixel rows 220, 222, and 224 are arranged on the other side of the interference prevention pattern 230. In this manner, the left-eye pixel rows 210, 212, and 214 and the right-eye pixel rows 220, 222, and 224 are arranged alternately, and the interference prevention pattern 230 is formed between a group of the left-eye pixel rows 210, 212, and 214 and a group of the right-eye pixel rows 220, 222, and 224. In FIG. 6, pixel rows may be divided into a group of left-eye pixel rows 210, 212, 214, and 216 and a group of right-eye pixel rows 220, 222, 224, and 226 in units of four pixel rows. The group of left-eye pixel rows 210, 212, 214, and 216 and the group of right-eye pixel rows 220, 222, 224, and 226 may be formed alternately in units of four pixel rows, and an interference prevention pattern 230 may be formed between the group of left-eye pixel rows 210, 212, 214, and 216 and the group of right-eye pixel rows 220, 222, 224, and 226. In this manner, the left and right-eye pixel groups may be formed in various different forms in addition to the above-described example where left and right-eye pixel groups are formed in units of two pixel rows.

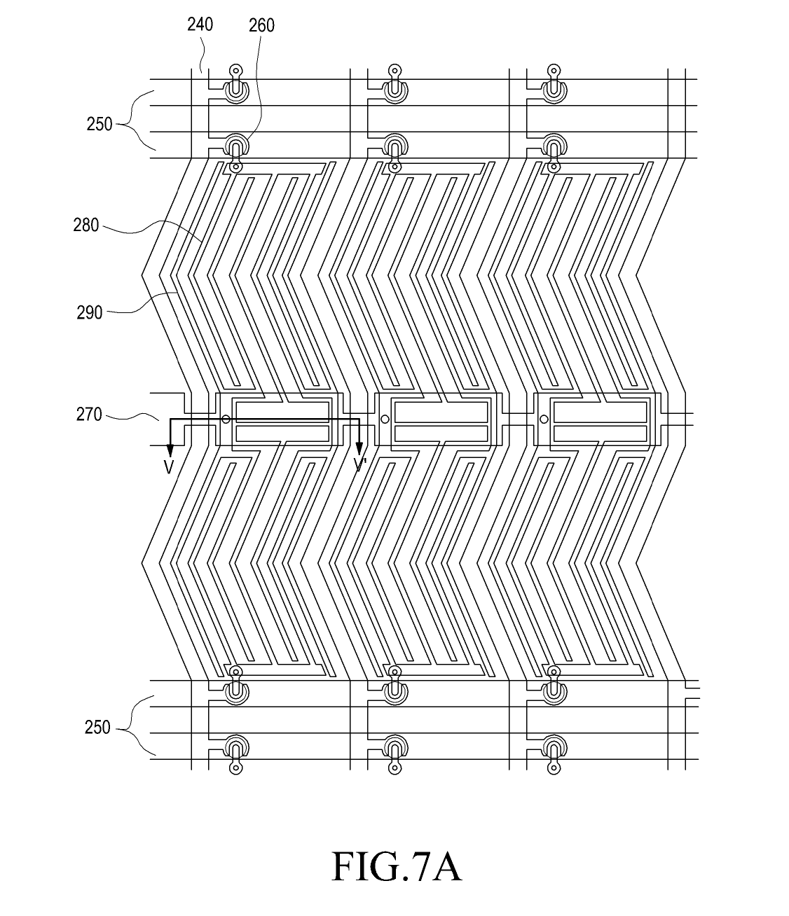

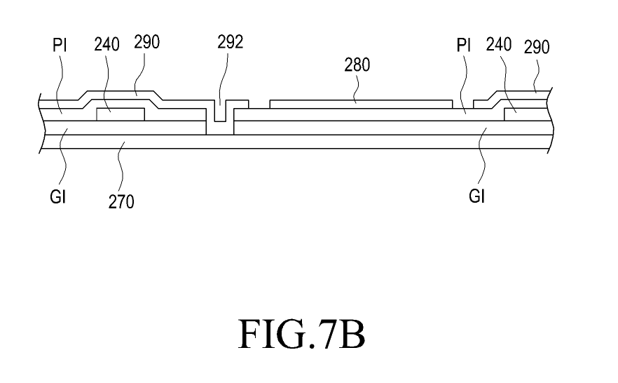

Referring to FIG. 7A, gate lines 250 may be formed in portions overlapping interference prevention patterns (not shown). Pixel electrodes 280, a common electrode 290, and pixels with switching elements 260 may be arranged between the gate lines 250 in a plurality of rows. Pixel electrodes 280 located in adjacent pixel rows are spaced apart from each other at a predetermined distance. Conventionally, light generated from a backlight unit may leak out between the pixels that are spaced apart. To prevent the light leakage, a storage wiring 270 may be disposed between adjacent pixel rows. The adjacent pixels may both overlap a storage capacitance electrode (or storage electrode), which is a portion of the storage capacitance wiring (or storage electrode line) 270 overlapping the pixel electrodes 280. Accordingly, adjacent pixels may overlap a storage capacitance electrode, forming a storage capacitance, to prevent light generated from the backlight unit from leaking through gaps between the adjacent pixel rows. The storage electrode and the storage electrode wiring may be formed of an opaque conductive layer to which an organic material with a low light reflectance or a layer of a material such as chromium oxide (CrOx) is added. An image quality of the display device may deteriorate if the storage electrode line 270 reflects external light incident from the user's viewing direction though the storage electrode line 270 blocks light from the backlight unit. FIG. 7A shows an In-Plane Switching (IPS)-mode electrode.

FIG. 7B is a cross-sectional view taken along a line V-V′ of FIG. 7A, and illustrates a portion of a vertical structure of FIG. 7A. A storage electrode line 270 may be formed on a lower glass substrate (not shown). A gate insulating film GI may be formed on the storage electrode line 270, and a data line 240 may be formed on the gate insulating film GI. A protective insulating film PI may be formed on the data line 240, and a pixel electrode 280 and a common electrode 290 may be formed on the protective insulating film PI. The common electrode 290 may be electrically connected to the storage electrode line 270 through a contact hole 292. The pixel electrode 280 may overlap a portion of the storage electrode line 270 to form a storage capacitance along with the gate insulating film GI and the protective insulating film PI. The structure of FIG. 7B will be more apparent from the following description of a substrate manufacturing process.

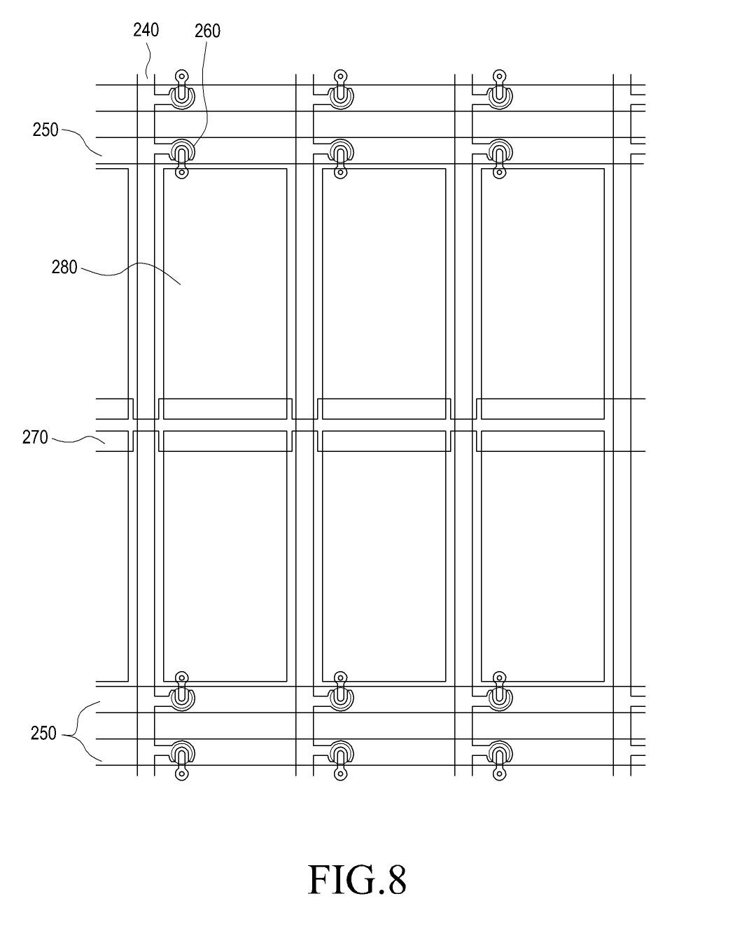

FIG. 8 shows a planar pixel electrode 280 used for a Twisted Nematic (TN)-mode or Vertical Alignment (VA)-mode display device, according to exemplary embodiments of the present invention. A vertical structure of FIG. 8 may be similar to the structure described in FIGS. 7A and 7B; therefore, repeated descriptions of similar elements in the structure have been omitted to avoid repetition. The display device in FIG. 8 is similar to the IPS-mode display device in FIG. 7A except that a common electrode formed on the corresponding substrate may not be formed. In FIG. 8, adjacent pixel rows may share a storage electrode wiring 270.

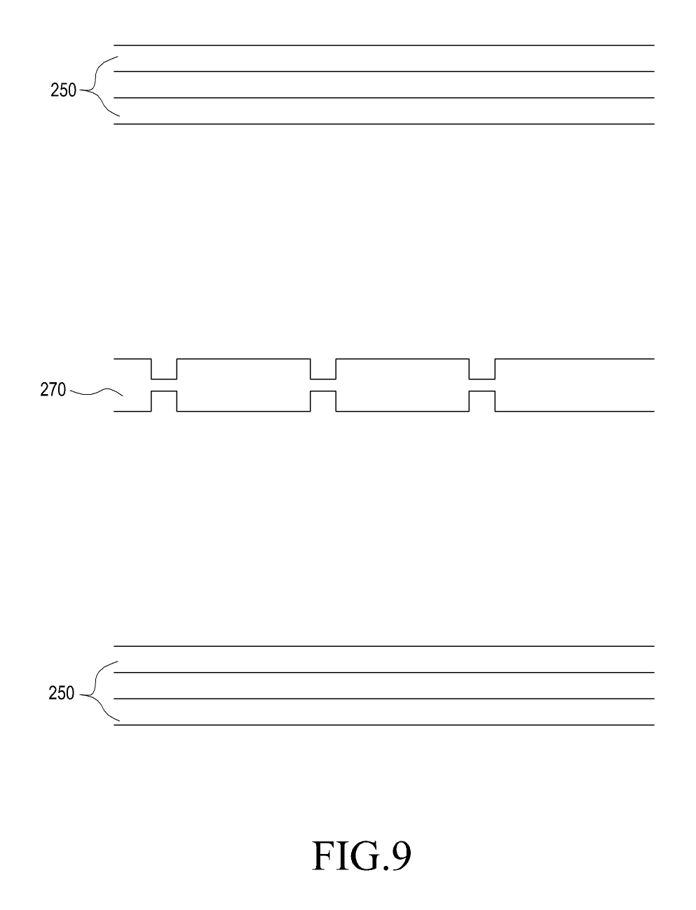

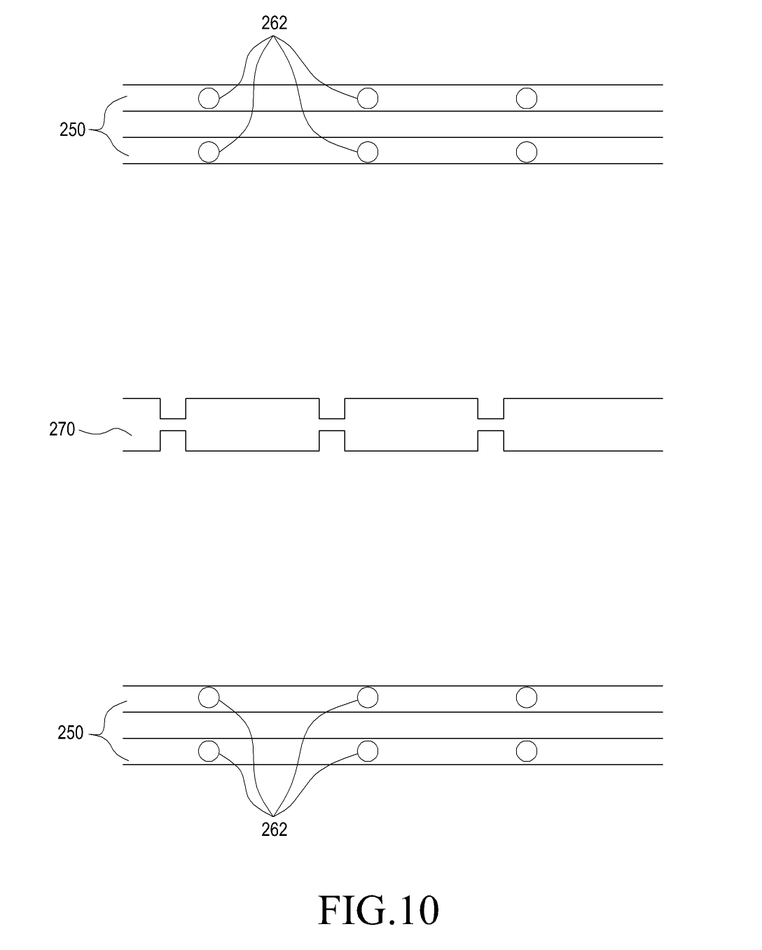

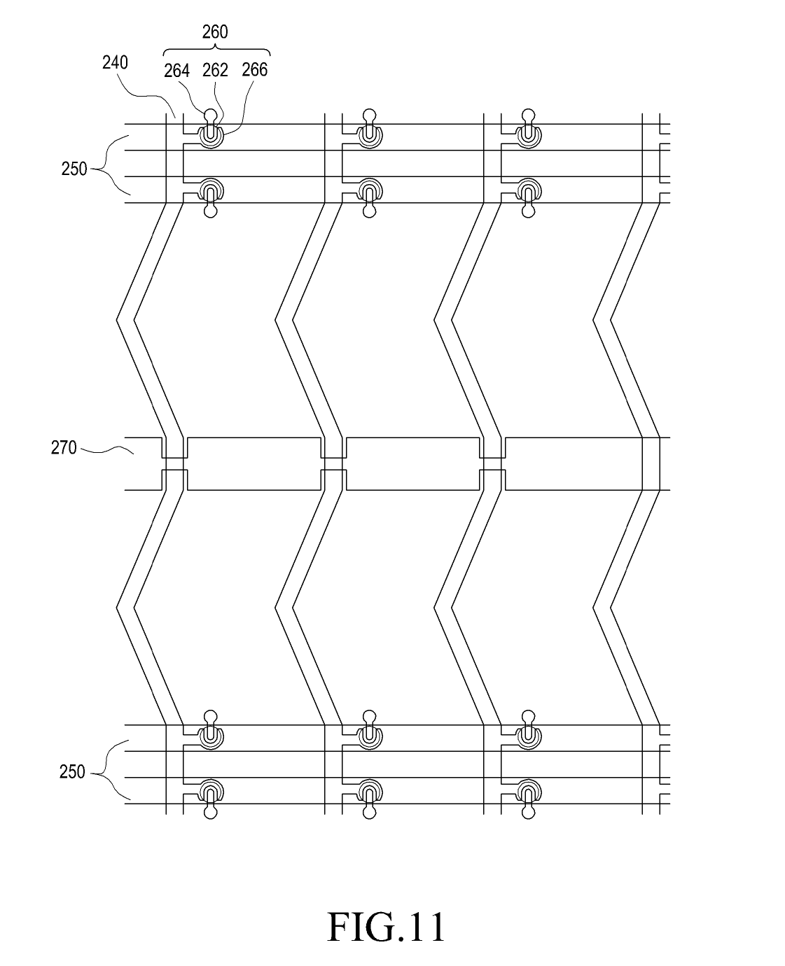

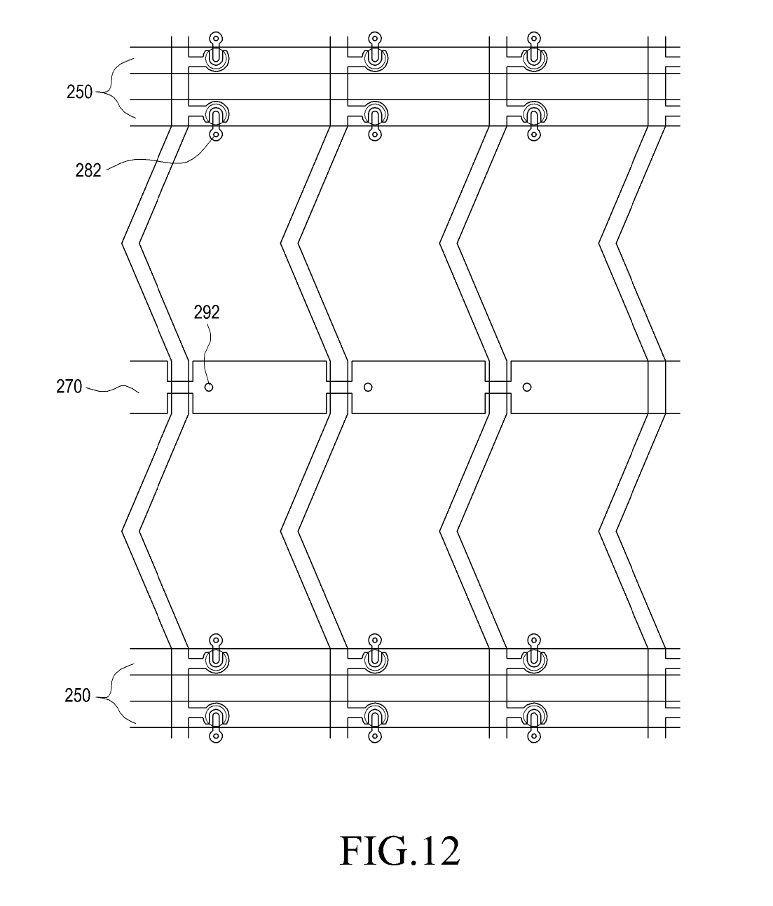

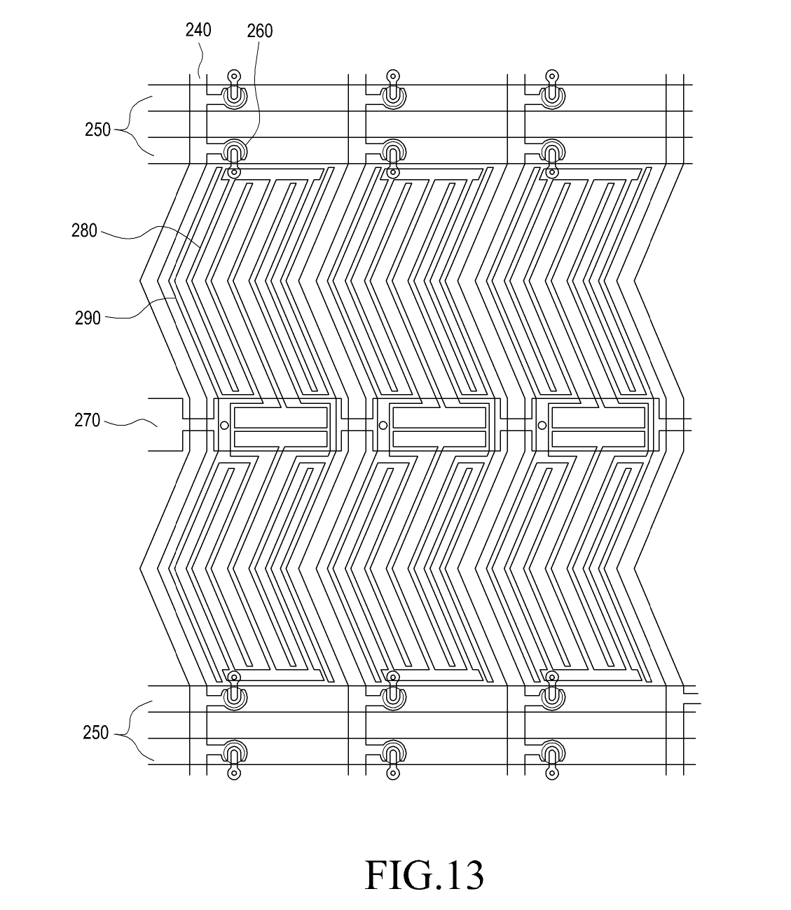

FIGS. 9, 10, 11, 12, and 13 show a process of manufacturing an IPS-mode substrate. Referring to FIG. 9, after a conductive layer is deposited on a glass substrate, gate lines 250 and a storage electrode wiring 270 may be formed by photolithography. After a transparent insulating film is disposed on the gate lines 250 and storage electrode wiring 270, semiconductor patterns 262 may be formed to overlap the portions corresponding to gate electrodes of gate lines 250 as shown in FIG. 10. The semiconductor patterns 262 may be formed by disposing a semiconductor layer over the substrate and then forming the semiconductor patterns 262 by treating the semiconductor layer with photolithography. Referring to FIG. 11, after a conductive layer for forming a data line 240, a source electrode 266, and a drain electrode 264 is disposed on the semiconductor pattern 262, the data line 240, the source electrode 266, and the drain electrode 264 may be formed by treating the conductive layer with photolithography. Referring to FIG. 12, after a transparent protective film is formed on the substrate on which the data line 240, the source electrode 266 and the drain electrode 264 are formed, a contact hole 282 for a pixel electrode and a contact hole 292 for a common electrode may be formed by removing part of the transparent protective film and part of the gate insulating film by photolithography so that part of the drain electrode 264 and part of the storage electrode line 270 may be exposed. Referring to FIG. 13, after a transparent conductive layer is disposed on the formed content holes 282 and 292, a pixel electrode 280 and a common electrode 290 may be formed by treating the transparent conductive layer with photolithography. As shown in FIG. 13, pixels in adjacent rows may share one electrode storage line to prevent light from a backlight unit from leaking at a portion where adjacent pixel electrodes are spaced apart from each other, and to ensure efficient use of the space.

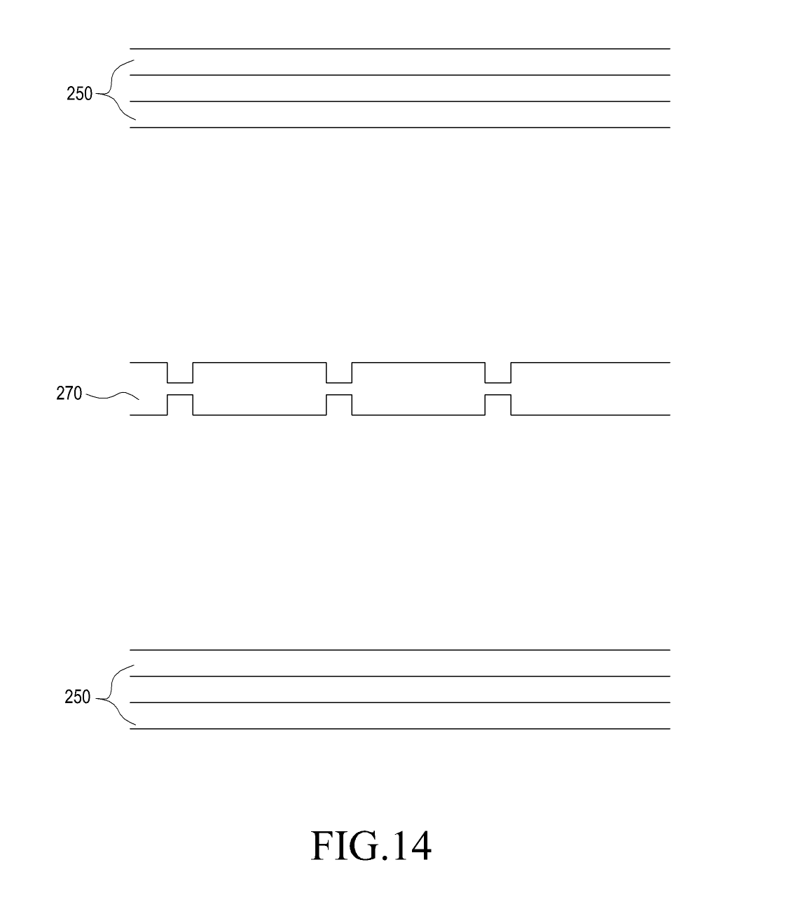

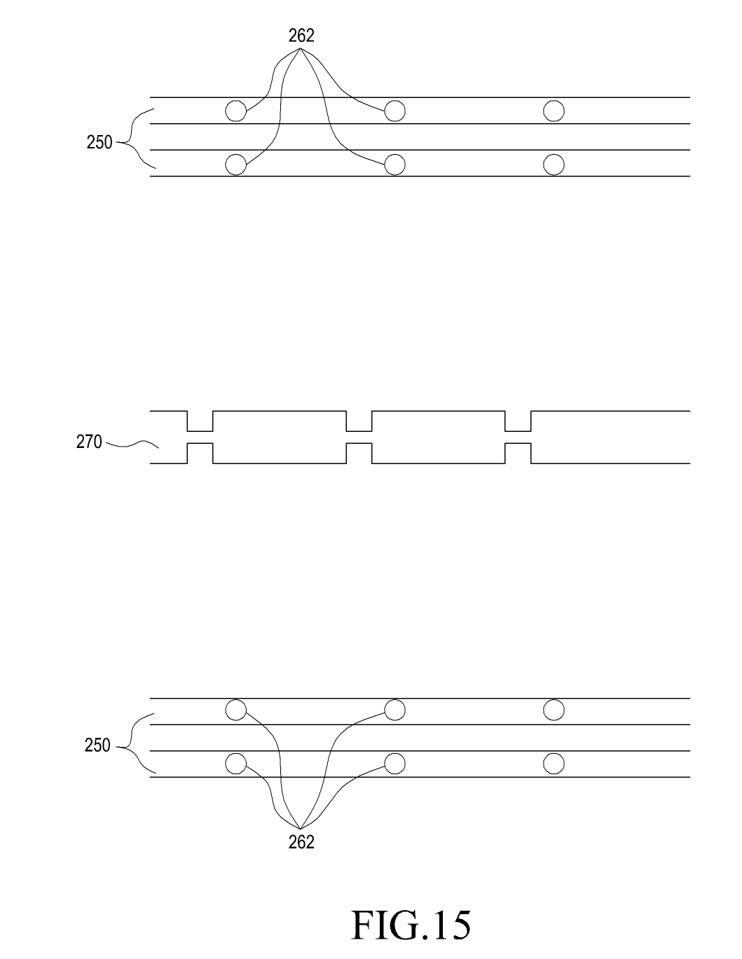

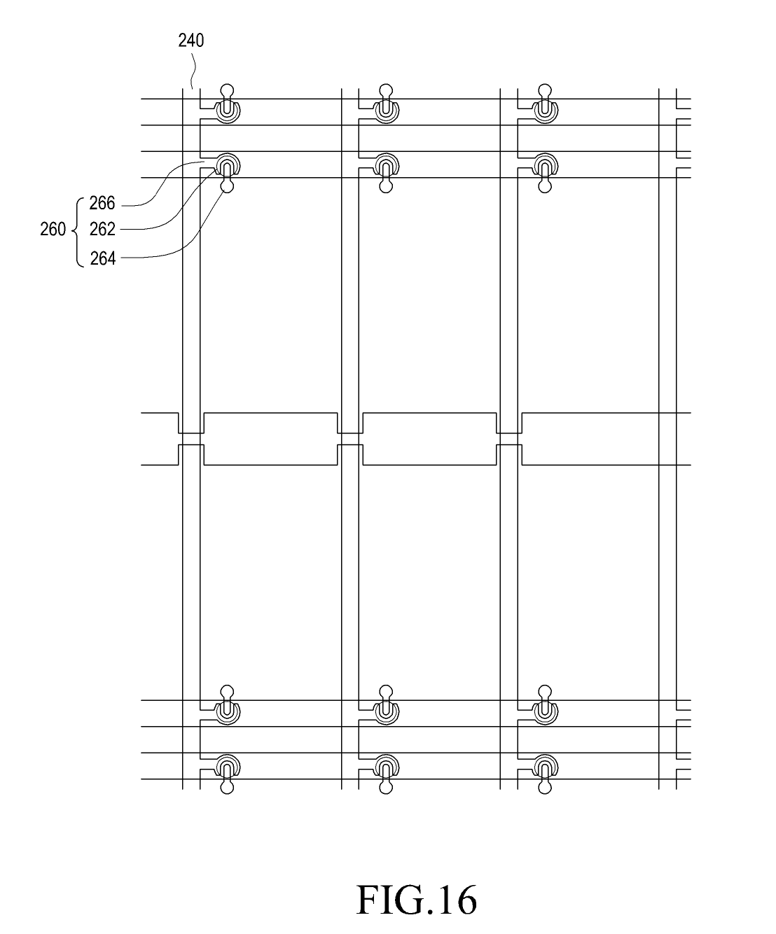

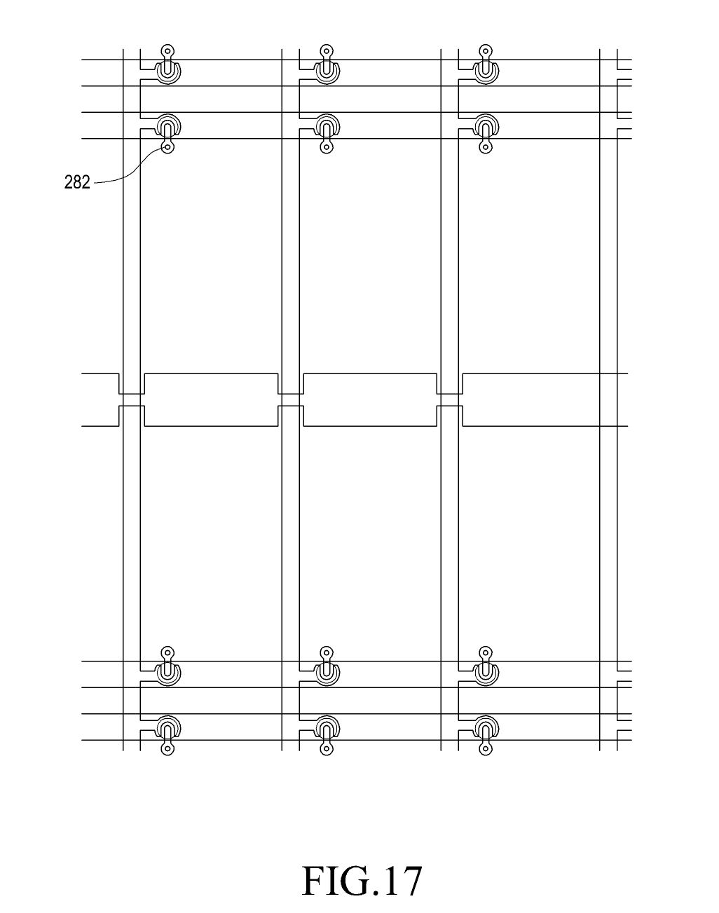

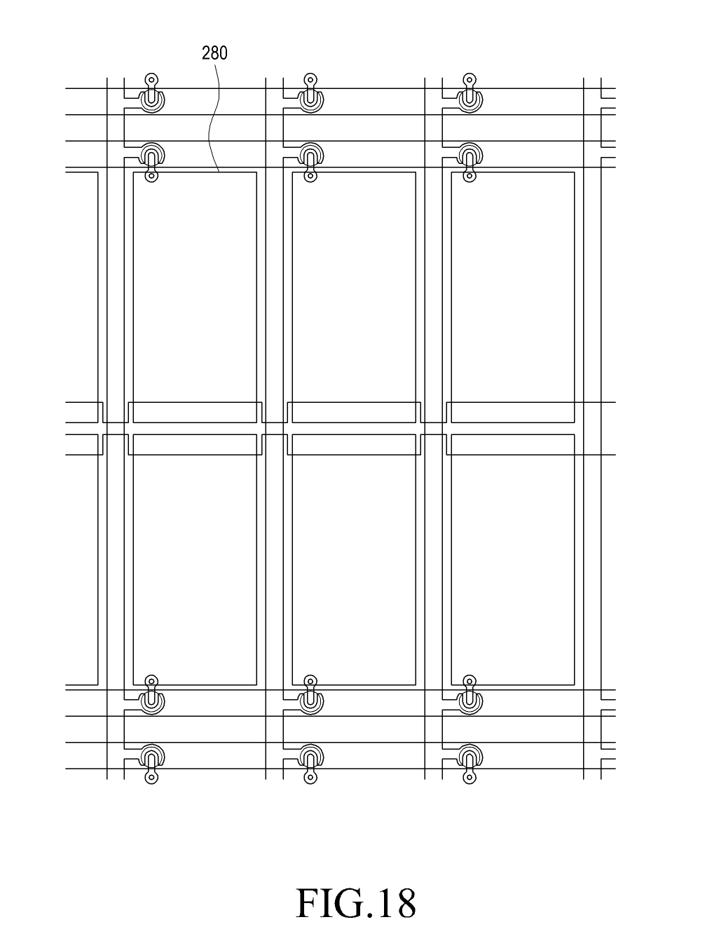

Referring to FIGS. 14, 15, 16, 17, and 18, a process of manufacturing the display device of FIG. 8 having planar electrodes used in the TN mode or the VA mode is shown. Referring to FIG. 14, after a conductive layer is disposed on a glass substrate (not shown), gate lines 250 and a storage electrode wiring 270 may be formed by treating the conductive layer with photolithography. After a transparent insulating film is disposed on the gate lines 250 and the storage electrode wiring 270, semiconductor patterns 262 may be formed to overlap the portions corresponding to gate electrodes of the gate lines 250 as shown in FIG. 15. The semiconductor patterns 262 may be formed by disposing a semiconductor layer on the substrate and forming the semiconductor patterns 262 by treating the semiconductor layer with photolithography. Referring to FIG. 16, after a conductive layer for forming a data line 240, a source electrode 266, and a drain electrode 264 is disposed on the semiconductor patterns 262, the data line 240, the source electrode 266, and the drain electrode 264 may be formed by treating the conductive layer with photolithography. Referring to FIG. 17, after a transparent protective film is formed on the substrate on which the data line 240, the source electrode 266, and the drain electrode 264 are formed, a contact hole 282 for a pixel electrode may be formed by removing part of the transparent protective film using photolithography so that part of the drain electrode 264 may be exposed. Referring to FIG. 18, after a transparent conductive layer is deposited on the formed contact hole 282, a pixel electrode 280 may be formed also by treating the transparent conductive layer with photolithography. The pixel electrode 280 may overlap a portion of the storage electrode line 270 to form a storage capacitance. As shown in FIG. 18, pixels in adjacent rows may share an electrode storage line to prevent light from a backlight unit from leaking at a portion where adjacent pixel electrodes are spaced apart from each other, and to ensure efficient use of the space.

Although it is assumed in the exemplary embodiments described with reference to FIGS. 9, 10, 11, 12, 13, 14, 15, 16, 17, and 18 that the data line patterns including the data line 240, the source electrode 266, and the drain electrode 264, and the semiconductor pattern 262 are formed by different photolithography processes, in some cases, these data line patterns may be formed using the same photolithography process.

As is apparent from the foregoing description, exemplary embodiments of the present invention may implement a stereoscopic image display device which prevents interference between left and right-eye images and has high-luminance characteristics secured by a high aperture ratio. Other effects may be derived from the foregoing detailed disclosure for implementing exemplary embodiments of the invention.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A display device, comprising:
pixels arranged in rows and columns, the pixels being divided into pixel groups;
interference prevention patterns formed between the pixel groups;
phase delay layers disposed on the interference prevention patterns and having different phases; and
at least one storage electrode line disposed between adjacent pixel groups, the at least one storage electrode line extending in a direction parallel to a direction the rows are extending in.

2. The display device of claim 1, wherein the at least one storage electrode line comprises a portion intersecting a data line configured to deliver a pixel signal to the pixels, a width of the at least one storage electrode line at the portion intersecting the data line being narrower than a width of the at least one storage electrode line at a portion other than the portion intersecting the data line.

3. The display device of claim 2, wherein the at least one storage electrode line comprises an upper protruding portion and a lower protruding portion overlapping pixel electrodes formed in each of the pixels.

4. The display device of claim 1, wherein the at least one storage electrode line comprises an upper protruding portions and a lower protruding portion overlapping pixel electrodes formed in each of the pixels.

5. A display device, comprising:
pixels arranged in a plurality of rows and a plurality of columns, wherein the plurality of rows comprise groups of adjacent rows;
interference prevention patterns disposed between adjacent groups of the groups of adjacent rows;
phase delay layers disposed on the interference prevention patterns and having different phase delay features; and
at least one storage electrode line disposed between the adjacent groups of adjacent rows, the at least one storage electrode line extending in a direction parallel to a direction the plurality of rows extend in.

6. The display device of claim 5, wherein the at least one storage electrode line comprises a portion intersecting a data line configured to deliver a pixel signal to the pixels, a width of the at least one storage electrode line at the portion intersecting the data line being narrower than a width of the at least one storage electrode line at a portion other than the portion intersecting the data line.

7. The display device of claim 6, wherein the at least one storage electrode line comprises at least one portion overlapping pixel electrodes formed in each of the pixels.

8. The display device of claim 5, wherein the at least one storage electrode line comprises at least one portion overlapping pixel electrodes formed in each of the pixels.

9. A display device, comprising:
pixels arranged in rows and columns, the pixels comprising:
first pixels arranged in a first direction;
second pixels arranged adjacent to the first pixels in the first direction;
third pixels arranged in the first direction to be spaced apart from the first pixels; and
fourth pixels arranged adjacent to the third pixels in the first direction;
a first pixel group comprising the first pixels and the second pixels;
a second pixel group comprising the third pixels and the fourth pixels and being adjacent to the first pixel group;
an interference prevention pattern disposed between the first pixel group and the second pixel group;
a first phase delay layer overlapping the first pixel group and extending in the first direction;
a second phase delay layer overlapping the second pixel group, extending in the first direction, and having different phase delay features compared to the phase delay features of the first phase delay layer;
a first storage electrode line extending between the first pixels and the second pixels in the first direction; and
a second storage electrode line extending between the third pixels and the fourth pixels in the first direction.

10. The display device of claim 9, wherein each of the first storage electrode line and the second storage electrode line comprises a portion intersecting data lines configured to deliver pixel signals to the pixels, a width of each of the first storage electrode line and the second storage electrode line at the portion intersecting the data lines being narrower than a width of the storage electrode line at a portion other than the portion intersecting the data lines.

11. The display device of claim 10, wherein each of the first storage electrode line and the second storage electrode line comprises a portion overlapping pixel electrodes formed in each of the pixels.

12. The display device of claim 9, wherein each of the first storage electrode line and the second storage electrode line comprises a portion overlapping pixel electrodes formed in each of the pixels.

13. A display device, comprising:
a plurality of pixel rows comprising at least a first group of pixel rows and a second group of pixel rows, the first group of pixel rows comprising at least a first pixel row and a second pixel row, the second group of pixel rows comprising at least a third pixel row and a fourth pixel row;
an opaque layer separating the first group of pixel rows from the second group of pixel rows;
at least one signal line overlapping the opaque layer and being connected to pixels in the second pixel row and pixels in the third pixel row; and
at least one storage electrode line overlapping a gap between the first pixel row and the second pixel row.

14. The display device of claim 13, wherein the at least one storage electrode line overlaps at least a portion of the first pixel row and at least a portion of the second pixel row.

15. The display device of claim 13, wherein a number of the at least one signal line is determined, at least in part, by a number of pixel rows in the first group of pixel rows overlapping a phase delay pattern and a number of pixels to which each of the at least one signal line is configured to provide a signal.
